(19) United States
(12) Patent Application Publication
(10) Pub. No.: US 2026/0253576 A1
(43) Pub. Date: Aug. 27, 2026

(54) ELECTRONIC DEVICE, OPERATING METHOD THEREOF, AND RECORDING MEDIUM

(71) Applicant: Samsung Electronics Co., Ltd., Suwon-si (KR)

(72) Inventors: Hyeoncheon JO, Suwon-si (KR); Kyungtae KIM, Suwon-si (KR); Hoseon SHIN, Suwon-si (KR); Jaeyeun YOON, Suwon-si (KR); Sanghyun LEE, Suwon-si (KR); Dongchoon HWANG, Suwon-si (KR)

(21) Appl. No.: 19/650,992

(22) Filed: Apr. 17, 2026

Related U.S. Application Data
(63) Continuation of application No. PCT/KR2024/015426, filed on Oct. 11, 2024.

(30) Foreign Application Priority Data
Oct. 24, 2023 (KR) 10-2023-0143311
Nov. 14, 2023 (KR) 10-2023-0157483

(51) Int. Cl. G10L 13/033; G10L 13/047; G10L 13/08

(52) U.S. Cl. CPC G10L 13/033; G10L 13/047; G10L 13/08

(57) ABSTRACT

This electronic device may comprise a communication circuit, a speaker, a processor, and a memory for storing instructions. The instructions, when executed by the processor, may be configured to cause the electronic device to transmit input text, corresponding to a user input, to a server via the communication circuit. The instructions, when executed by the processor, may be configured to cause the electronic device to receive, from the server via the communication circuit, response text corresponding to the input text and generated by the server. The instructions, when executed by the processor, may be configured to cause the electronic device to identify a reception speed of the response text. The instructions, when executed by the processor, may be configured to cause the electronic device to determine the attribute of a response voice corresponding to the response text on the basis of the reception speed. The instructions, when executed by the processor, may be configured to cause the electronic device to output a voice signal corresponding to the response text via the speaker on the basis of the attribute of the response voice. Various other embodiments are also possible.

### CROSS-REFERENCE TO RELATED APPLICATION(S)

This application is a continuation application, claiming priority under 35 U.S.C. § 365(c), of an International application No. PCT/KR 2024/015426, filed on Oct. 11, 2024, which is based on and claims the benefit of a Korean patent application number 10-2023-0143311, filed on Oct. 24, 2023, in the Ministry of Intellectual Property (MOIP), and of a Korean patent application number 10-2023-0157483, filed on Nov. 14, 2023, in the Ministry of Intellectual Property (MOIP), the disclosure of each of which is incorporated by reference herein in its entirety.

### TECHNICAL FIELD

The disclosure relates to an electronic device, a method for operating the same, and a recording medium according to an embodiment.

### BACKGROUND ART

A text-to-speech (TTS) system receives a word-or sentence-specific text input and creates and outputs a speech. This aims to create a speech that accurately and naturally pronounces each word. Therefore, technology has been conventionally developed to receive a sentence-specific, or even word-specific, input and give an overall natural intonation through syntax understanding so as to output speech in a more natural fashion. In other words, advance in technology has been directed to creating high-quality speech in a context where regular inputs and regular outputs are made.

However, such a TTS system is limited as it is required to operate under the assumption that data to be input is prepared. Text should be entered at a predetermined speed or higher to create a speech that is not awkward when the user hears the speech and, if the text is entered slower than the predetermined speed, the speech may drop out in the middle to give no feedback to the user.

The above-described information may be provided as related art for the purpose of helping understanding of the disclosure. No claim or determination is made as to whether any of the foregoing is applicable as background art in relation to the disclosure.

### DISCLOSURE OF INVENTION

Solution to Problems

According to an embodiment, an electronic device is operable to convert text provided from a generative model (e.g., large language model (LLM)) that generates data into speech and output the speech.

According to an embodiment, an electronic device may comprise communication circuitry, a speaker, a processor, and memory storing instructions. The instructions may be configured to, when executed by the processor, enable the electronic device to transmit, to a server through the communication circuitry, an input text corresponding to a user input. The instructions may be configured to, when executed by the processor, enable the electronic device to receive, from the server through the communication circuitry, a response text corresponding to the input text, generated by the server. The instructions may be configured to, when executed by the processor, enable the electronic device to identify a reception speed of the response text. The instructions may be configured to, when executed by the processor, enable the electronic device to, based on the reception speed, determine an attribute of a response speech corresponding to the response text. The instructions may be configured to, when executed by the processor, enable the electronic device to, based on the attribute of the response speech, output, through the speaker, a speech signal corresponding to the response text.

According to an embodiment, a method for operating an electronic device may comprise transmitting an input text corresponding to a user input to a server. The method may comprise receiving, from the server, a response text corresponding to the input text, generated by the server. The method may comprise identifying a reception speed of the response text. The method may comprise, based on the reception speed, determining an attribute of a response speech corresponding to the response text. The method may comprise outputting a speech signal corresponding to the response text, based on the attribute of the response speech.

According to an embodiment, in a computer-readable recording medium storing instructions configured to perform at least one operation by a processor of an electronic device, the at least one operation may comprise transmitting an input text corresponding to a user input to a server. The at least one operation may comprise receiving, from the server, a response text corresponding to the input text, generated by the server. The at least one operation may comprise identifying a reception speed of the response text. The at least one operation may comprise, based on the reception speed, determining an attribute of a response speech corresponding to the response text. The at least one operation may comprise outputting a speech signal corresponding to the response text, based on the attribute of the response speech.

### BRIEF DESCRIPTION OF DRAWINGS

FIG. 1 is a block diagram illustrating an electronic device in a network environment according to an embodiment;

FIG. 2 is a block diagram illustrating an electronic device according to an embodiment;

FIG. 3 is a block diagram illustrating an electronic device and a server according to an embodiment;

FIG. 4 is a view illustrating operations of an electronic device according to an embodiment;

FIG. 5 is a flowchart illustrating an operation method of an electronic device according to an embodiment;

FIG. 6 is a view illustrating operations of an electronic device according to an embodiment;

FIG. 7 is a flowchart illustrating an operation method of an electronic device according to an embodiment;

FIG. 8 is a view illustrating operations of an electronic device according to an embodiment;

FIG. 9 is a view illustrating operations of an electronic device according to an embodiment;

FIG. 10 is a view illustrating operations of an electronic device according to an embodiment;

FIG. 11 is a view illustrating operations of an electronic device according to an embodiment;

FIG. 12 is a flowchart illustrating an operation method of an electronic device according to an embodiment;

FIG. 13A is a view illustrating operations of an electronic device according to an embodiment;

FIG. 13B is a view illustrating operations of an electronic device according to an embodiment;

FIG. 14A is a view illustrating operations of an electronic device according to an embodiment; and

FIG. 14B is a view illustrating operations of an electronic device according to an embodiment.

### MODE FOR THE INVENTION

Embodiments of the present invention are now described with reference to the accompanying drawings in such a detailed manner as to be easily practiced by one of ordinary skill in the art. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

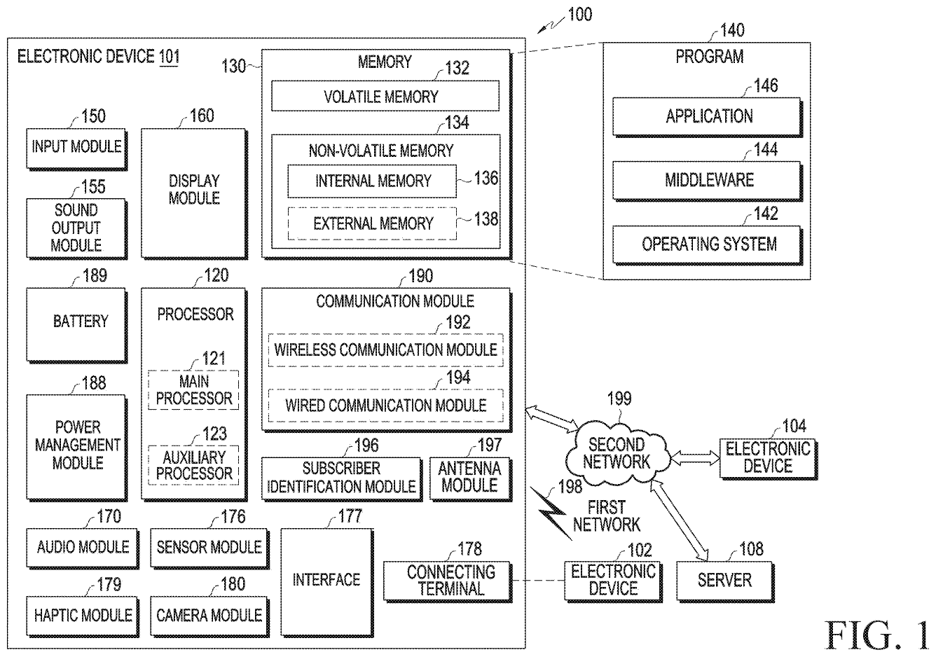

FIG. 1 is a block diagram illustrating an electronic device 100 in a network environment according to an embodiment.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth^{TM}, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

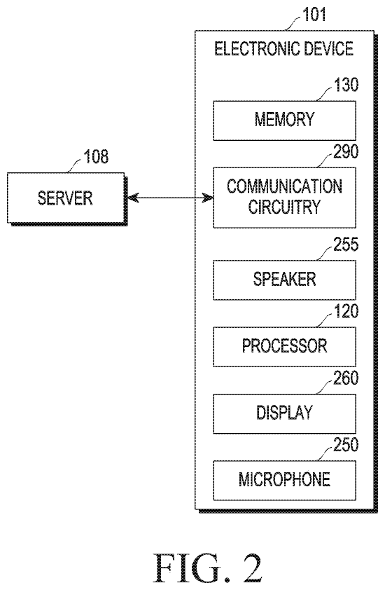

FIG. 2 is a block diagram illustrating an electronic device 101 according to an embodiment.

Referring to FIG. 2, according to an embodiment, an electronic device 101 may include a speaker 255 (e.g., the sound output module 155 of FIG. 1). The electronic device 101 may include a display 260 (e.g., the display module 160 of FIG. 1). The electronic device 101 may include a microphone 250 (e.g., the input module 250 of FIG. 1). The electronic device 101 may include a communication circuitry 290 (e.g., the communication module 190 of FIG. 1). For example, the electronic device 101 may be configured to communicate with the server 108 through the communication circuitry 290 (e.g., the communication module 190 of FIG. 1). The electronic device 101 may include a processor 120. The operation of the electronic device 101 may be controllable by the processor 120. Hereinafter, the operation of the electronic device 101 may be understood as the operation of the electronic device 101 (or a component included in the electronic device 101) by the processor 120. The electronic device 101 may include memory 130. The memory 130 may include instructions. The instructions, when executed by the processor 120, may enable the electronic device 101 to perform a specific operation.

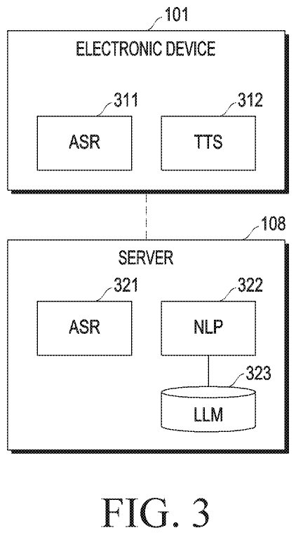

FIG. 3 is a block diagram illustrating an electronic device 101 and a server 108 according to an embodiment.

At least some of the components of the server 108 described below may be included in the electronic device 101. For example, at least some of the operations of the server 108 may be performed by the electronic device 101. For example, the electronic device 101 may process data using a component included in the electronic device 101 without transmitting data to the server 108 or receiving data from the server 108. For example, the electronic device 101 may include a generative model (e.g., a large language model (LM)).

According to an embodiment, the electronic device 101 (e.g., the processor 120) may include a speech recognition module (e.g., an automatic speech recognition (ASR) 311). The electronic device 101 (e.g., the processor 120) is configured to perform speech recognition using a speech recognition module (e.g., the ASR 311). The implementation method of the speech recognition module (e.g., the ASR 311) is not limited. For example, the electronic device 101 may be configured to convert a speech obtained through the microphone 250 into text using a speech recognition module (e.g., the ASR 311). The electronic device 101 may be configured to transmit data corresponding to the converted text to the server 108 through the communication circuitry 290. For example, the electronic device 101 may be configured to convert a speech (e.g., an input speech) corresponding to a user input (e.g., a speech input) into a text (e.g., an input text) and may be configured to transmit the text to the server 108. According to an embodiment, the electronic device 101 may be configured to transmit a text (e.g., an input text) corresponding to a user input (e.g., a text input) to the server 108. “Input text” may be text input to a generative model (e.g., LLM). The “response text” to be described below may be text output (e.g., generated) from the generative model (e.g., LLM) based on the input text.

According to an embodiment, the server 108 may include a speech recognition module (e.g., the ASR 321). For example, the electronic device 101 may be configured to transmit data corresponding to a speech obtained through the microphone 250 to the server 108 through the communication circuitry 290. The server 108 may be configured to convert data (e.g., speech) provided from the electronic device 101 into text (e.g., input text) using the speech recognition module (e.g., the ASR 321).

According to an embodiment, the server 108 may include a natural language processing (NLP) 322 module. For example, the NLP 322 may be processed using an artificial neural network-based large language model (LLM) 323. The LLM 323, which is one of the artificial neural network models, may provide a function of being pre-trained with a large-scale dataset to derive an input for various questions as a response under the influence of the large-scale dataset. The server 108 may be configured to generate (e.g., output) a response text using the artificial neural network model (e.g., the LLM 323) based on the input text. When the LLM 323-based NLP 322 generates the response text, the response text may be sequentially generated in language units (e.g., phoneme units, syllable units, word units, or sentence units). The response text may be output at an irregular speed due to the state of the model, the resource allocation state of the system, or the characteristics of the input text. The server 108 may transmit a response text output (e.g., generated) based on the input text to the electronic device 101.

According to an embodiment, the electronic device 101 (e.g., the processor 120) may include a text-to-speech (TTS) module 312. The electronic device 101 (e.g., the processor 120) may be configured to convert text into speech using the TTS 312. For example, the electronic device 101 may be configured to convert the response text received from the server 108 into a speech using the TTS 312. The implementation method of the text-to-speech conversion module (e.g., TTS 312) is not limited.

According to an embodiment, the server 108 may include a text-to-speech conversion module (e.g., TTS). The server 108 may be configured to convert text into speech using TTS. For example, the server 108 may convert the response text generated using the artificial neural network model (e.g., the LLM 323) into a speech using TTS. The server 108 may be configured to transmit the speech generated using TTS to the electronic device 101. The electronic device 101 may be configured to receive a speech generated using TTS from the server 108.

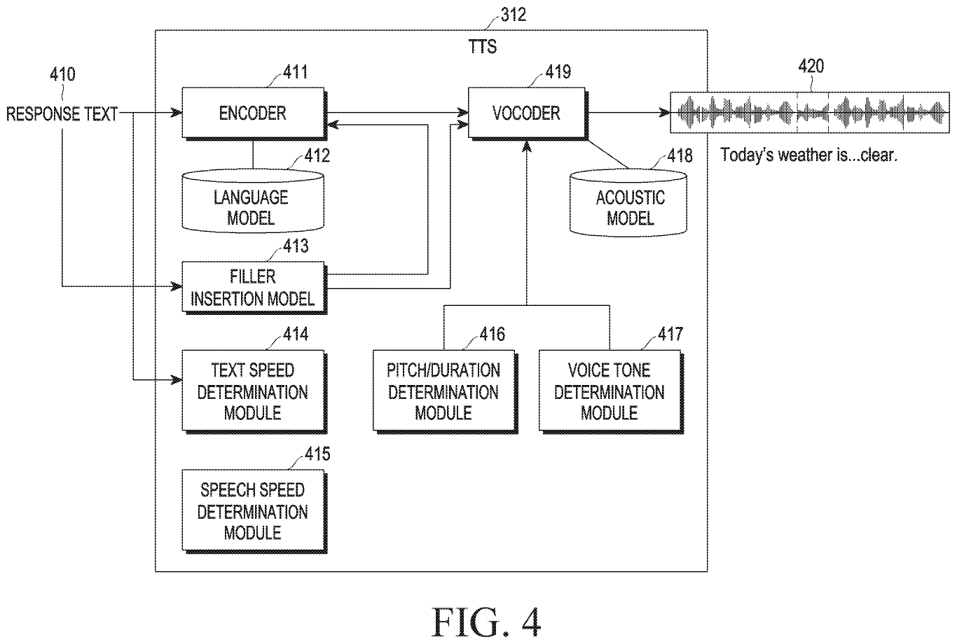

FIG. 4 is a view illustrating operations of an electronic device 101 according to an embodiment.

Referring to FIG. 4, the TTS 312 of the electronic device 101 may be described.

According to an embodiment, the response text 410 may include a response text generated in an LLM-based system. The response text 410 may be input to the TTS 312. For example, the electronic device 101 may be configured to receive a response text from the server 108. The electronic device 101 may be configured to sequentially receive the response text from the server 108. For example, the electronic device 101 may receive a first section of the response text from the server 108 at a first time point and may receive a second section of the response text at a second time point. According to an embodiment, the electronic device 101 may operate based on the response text provided from the LLM included in the electronic device 101.

According to an embodiment, the encoder 411 may be configured to generate (or predict) a linguistic feature for generating a speech from a character string. The encoder 411 may be configured to generate (or predict) how phonemes and character groups required for speech generation are pronounced from a character string (e.g., a response text). For example, the encoder 411 may operate based on the language model 412. For example, the linguistic features may include pronunciation, accent, interval, and intonation of the text. For example, the linguistic features may include a pronunciation sequence (e.g., phoneme sequence, syllable sequence) of the response text. For example, the linguistic feature may be a form of an N-gram of the pronunciation unit (e.g., phoneme, syllable).

According to an embodiment, the text speed determination module 414 (e.g., token rate decision) may be configured to determine (or identify or calculate) the reception speed (e.g., text speed) of the response text. The text speed determination module 414 may record a time interval of the incoming response text 410 and calculate an average time. The text speed determination module 414 may be configured to measure the time interval of the input values provided from the LLM 323 through the response text 410, and calculate the average of the input values from the present to n previous values. The text speed determination module 414 may be configured to calculate the number of words received per unit time of the response text (e.g., the reception speed of the response text). Data obtained by the text speed determination module 414 may be provided to the speech speed determination module 415.

According to an embodiment, the speech speed determination module 415 (e.g., output TTS rate decision) may be configured to determine (or identify or calculate) the playback speed (e.g., speech speed) of the response speech to be generated, based on data provided by the text speed determination module 414. The speech speed determination module 415 may be configured to probabilistically predict the time interval of the response text to be received (or the number of words per unit time of the response text to be received) and determine the playback speed of the response speech to be generated, based on the data provided by the text speed determination module 414. For example, the speech speed determination module 415 may be configured to identify the reception speed of the response text based on the data provided by the text speed determination module 414. When the reception speed of the response text is maintained at a speed greater than or equal to a reference value, the speech speed determination module 415 may be configured to determine a normal speed (e.g., the default playback speed) as the playback speed of the speech. The speech speed determination module 415 may be configured to determine a playback speed slower than the normal speed (e.g., a default playback speed) as the playback speed of the speech, based on the reception speed of the response text being less than the reference value but being able to generate the speech to be generated at a speed or tone that is not inconvenient to hear. The speech speed determination module 415 may be configured to determine the playback speed of the speech in a moving average manner. The speech speed determination module 415 may be configured to determine the playback speed of the speech corresponding to the next sentence based on the playback speed of the speech corresponding to the previous sentence. For example, referring to Equation 1, when the playback speed of the response speech corresponding to the reception speed of the response text at the second time point after the first time point is calculated as x-fold speed, the speech speed determination module 415 may be configured to determine the playback speed (e.g., rₙ of Equation 1) of the response speech corresponding to the reception speed of the response text at the second time point, based on the playback speed (e.g., rn-1 of Equation 1) of the response speech corresponding to the reception speed of the response text at the first time point (Equation 1: rₙ=a·x+(1−a)rₙ₋₁) For example, the speech speed determination module 415 may be configured to determine to keep the playback speed of the response speech corresponding to one sentence constant. Equation 1 is only an example for helping understanding, and embodiments of the disclosure may not be limited thereto. For example, Equation 1 may be modified, applied, or extended in various ways.

According to an embodiment, the pitch/duration determination module 416 (e.g., pitch/duration predictor) may be configured to determine the most appropriate pitch and duration based on the response text received so far in a situation where the input of the entire sentence may not be considered. The pitch/duration determination module 416 may be configured to determine the pitch (e.g., accent) and duration of the speech to be generated corresponding to the response text received so far, based on the playback speed determined by the speech speed determination module 415.

According to an embodiment, the voice tone determination module 417 (e.g., speech variator) may be configured to adjust the speed of the response speech based on the playback speed of the response speech. The voice tone determination module 417 may be configured to change the voice tone based on the playback speed of the response speech. The voice tone determination module 417 may be configured to determine the speed and/or voice tone so that the user may hear the result of slowly adding emphasis to the words or phrases of the generated language. For example, determining the tone may be slowly and clearly pronouncing “giraffe” as “girrrrraffe” so that a child learning to speak may understand it well. Based on the determination of the speed and voice tone of the response speech by the voice tone determination module 417, it may be less inconvenient for the user to hear than when only the speed of the response speech is determined.

According to an embodiment, when the time interval of the incoming response text exceeds the reference value or when the number of words received per unit time of the response text is less than the reference value, the filler insertion module 413 (e.g., filler insertion decision) may be configured to determine that it is difficult to generate a normally hearable speech, and may be configured to determine to add a filler (e.g., an additional speech) filling an empty time slot of the generated speech. The filler may be an additional speech to be inserted between the response speeches. The filler insertion module 413 may be configured to provide, to the encoder 411 or the vocoder 419, a signal that enables generation of a filler (e.g., an additional speech) to fill an empty space of the response speech corresponding to the response text, based on the reception speed of the response text being less than the reference value. The filler (e.g., an additional speech) may be harmonized with the content of the received response text or the content of the generated response speech to be generated as a speech of a tone that is not awkward for the user to hear, thereby filling an empty space of the response speech. The filler (e.g., an additional speech) may include a speech sound and/or a non-speech sound. For example, the filler (e.g., an additional speech) may be stored in a waveform form corresponding to a plurality of sounds. For example, the filler (e.g., an additional speech) may be synthesized by inputting additional text to the TTS 312. One of a plurality of types of fillers (e.g., an additional speech) may be selected. The type of filler (e.g., an additional speech) may be selected based on the reception speed of the response text. The type of filler (e.g., an additional speech) may include a designated sentence indicating a mute, a designated speech sound, a nasal sound, a natural sound, a beep, white noise, or an output delay. For example, based on the reception speed of the response text being included in a first range (e.g., a slightly slower degree), the type of the filler (e.g., an additional speech) may be determined to be mute (or pause). The length of the mute (or pause) may be determined based on the reception speed of the response text. For example, based on the reception speed of the response text being included in a second range (e.g., a medium slow level), a designated speech sound (e.g., “uhm . . . ”, “Wait a minute”) or a designated non-speech sound (e.g., natural sound (e.g., wind sound, rain sound), beep (e.g., tu-tu-), or white noise) may be determined as a filler (e.g., an additional speech). For example, based on the reception speed of the response text being included in a third range (e.g., a very slow degree), a designated sentence (e.g., “the response is being delayed somewhat”) indicating an output delay may be determined as a filler (e.g., an additional speech). For example, the filler (e.g., an additional speech) may be a sound recorded with a voice different from that of the TTS 312. For example, the filler (e.g., the additional speech) may be synthesized by a second TTS (e.g., the TTS 312) corresponding to a second voice type, which is different from a first TTS (e.g., the TTS 312) corresponding to a first voice type. A language model (e.g., 412) or an acoustic model (e.g., 412) different from the first TTS (e.g., the TTS 312) or an acoustic model (e.g., 418) may be used as the second TTS (e.g., the TTS 312) corresponding to the filler (e.g., the additional speech). The filler (e.g., an additional speech) may be selected by the user. The filler (e.g., an additional speech) may be repeatedly played. For example, the repeated playback time of the filler (e.g., an additional speech) may be designated by the user or may be determined by the electronic device 101 based on the reception speed of the response text. The magnitude (e.g., volume) of the output of the filler (e.g., an additional speech) may be determined based on the reception speed of the response text. For example, when the electronic device 101 receives the first section of the response text at the first time point and the second section of the response text at the second time point, the electronic device 101 may be configured to determine the magnitude of the output of the filler, based on the interval between the first time point and the second time point. For example, the electronic device 101 may be configured to determine that the magnitude of the output of the filler naturally increases from a small volume to a certain level of volume in proportion to the time for waiting for the response text.

According to an embodiment, the vocoder 419 may be configured to generate a speech (e.g., the speech signal 420) appropriate for the user to hear. For example, the vocoder 419 may be configured to operate based on the acoustic model 418. The vocoder 419 may be configured to generate a speech signal 420 (e.g., a speech waveform) based on data (or a signal) provided from each module of the TTS 312. For example, the vocoder 419 may be configured to generate a speech signal based on the playback speed of the response speech. The vocoder 419 may be configured to adjust the length (or the number of unit phonemes) for each phoneme section of the pronunciation generated by the encoder 411 based on the duration information determined by the pitch/duration determination module 416, determine an acoustic feature vector corresponding to the adjusted pronunciation string, and generate a speech signal using the determined acoustic feature vector.

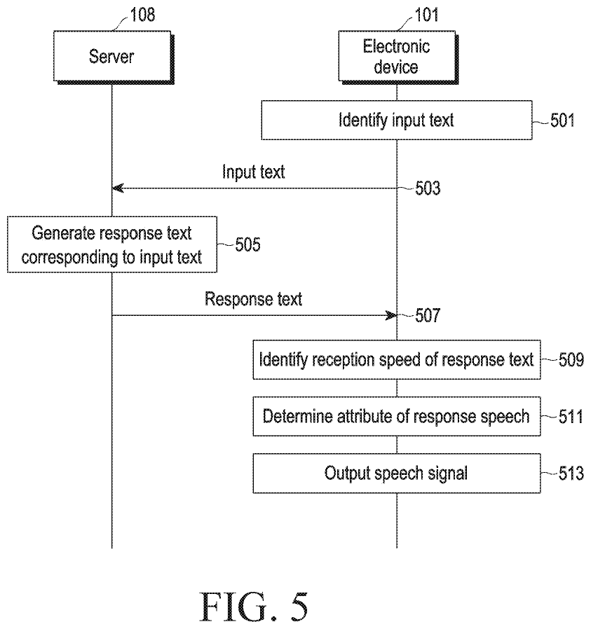

FIG. 5 is a flowchart illustrating an operation method of the electronic device 101 according to an embodiment. FIG. 5 may be described with reference to the above described embodiments and embodiments described below.

At least some of the operations of FIG. 5 may be omitted. The operation order of the operations of FIG. 5 may be changed. At least two of the operations of FIG. 5 may be performed in parallel. Operations other than the operations of FIG. 5 may be performed before, during, or after performing the operations of FIG. 5.

Referring to FIG. 5, in operation 501, according to an embodiment, the electronic device 101 (e.g., the processor 120) is configured to identify an input text corresponding to a user input. In operation 503, according to an embodiment, the electronic device 101 (e.g., the processor 120) is configured to transmit the input text to the server 108. For example, the electronic device 101 is configured to identify input text corresponding to the user input (e.g., a mouse, a keyboard, a key (e.g., a button), a touch screen, or a digital pen (e.g., a stylus pen)). The electronic device 101 may be configured to transmit the identified input text to the server 108. For example, the electronic device 101 may identify the input text using the ASR 311, based on the user input (e.g., a speech identified through the microphone 250). The electronic device 101 may be configured to transmit the identified input text to the server 108. For example, the electronic device 101 may be configured to transmit data (e.g., speech) corresponding to the user input (e.g., speech identified through the microphone 250) to the server 108. The server 108 may be configured to identify the input text using the ASR 321, based on the data (e.g., speech) provided from the electronic device 101.

In operation 505, according to an embodiment, the server 108 is configured to generate a response text corresponding to the input text, based on the LLM 323. Each section of the response text may be sequentially generated. The sections of the response text may include a language unit (e.g., a phoneme unit, a syllable unit, a word unit, a phrase unit, or a sentence unit).

In operation 507, according to an embodiment, the server 108 is configured to transmit the generated response text to the electronic device 101. The electronic device 101 may be configured to receive a response text from the server 108. The electronic device 101 may be configured to sequentially receive sections of the response text from the server 108.

In operation 509, according to an embodiment, the electronic device 101 (e.g., the processor 120) is configured to identify (or determine or calculate) the reception speed of the response text. For example, the reception speed of the response text may include a time interval of the incoming response text and/or the number of words received per unit time of the response text.

In operation 511, according to an embodiment, the electronic device 101 (e.g., the processor 120) is configured to determine the attribute of the response speech corresponding to the response text, based on the reception speed of the response text. The attribute of the response speech may include a playback speed, a voice tone, and/or whether to insert a filler of the response speech.

In operation 513, according to an embodiment, the electronic device 101 (e.g., the processor 120) is configured to output a speech signal corresponding to the response text, based on the attribute of the response speech.

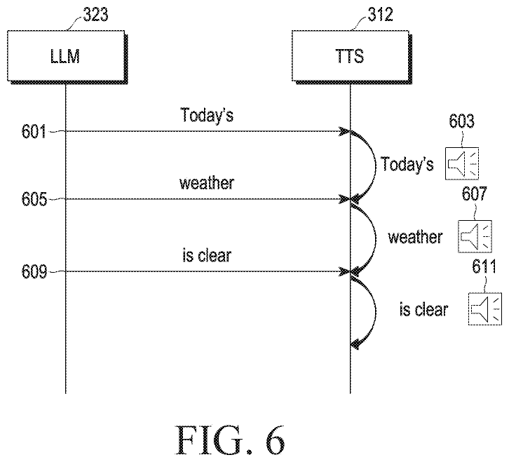

FIG. 6 is a view illustrating operations of an electronic device 101 according to an embodiment.

FIG. 6 is the view illustrating an embodiment of outputting the speech signal at the default playback speed without voice change (e.g., playback speed change and/or voice tone change) in the state in which the reception speed of the response text is sufficient. For example, referring to FIG. 6, an LLM (e.g., the LLM 323 included in the server 108 or the LLM included in the electronic device 101) may be configured to generate a response text. The generated response texts 601, 605, and 609 may be provided to the TTS 312 (e.g., the electronic device 101). FIG. 6 illustrates that the response text is directly transferred from the LLM (e.g., 323) to the TTS (e.g., 312), but this is for convenience of description. FIG. 6 illustrates that the response text is generated in the LLM (e.g., 323), and the generated response texts (e.g., 601, 605, and 609) are finally transferred to the TTS (e.g., 312). The transfer (or transmission) of the response text may be understood with reference to the description of the embodiment of FIG. 5. For example, the server 108 may be configured to transmit the response text generated by the LLM 323 to the electronic device 101. The electronic device 101 may be configured to convert the response text received from the server 108 into a speech signal using the TTS 312. As described above, according to an embodiment, at least some of the components of the server 108 may be included in the electronic device 101. At least some of the operations of the server 108 may be performed by the electronic device 101. For example, the electronic device 101 may include an LLM. For example, the response text generated by the LLM of the electronic device 101 may be finally input to the TTS (e.g., 312) of the electronic device 101. Hereinafter, at least some of the components of the server 108 may be included in the electronic device 101, and for example, at least some of the operations of the server 108 may be performed by the electronic device 101, and for convenience of description, a description of an embodiment in which the electronic device 101 performs operations without the server 108 is omitted.

In FIG. 6, a first section 601 (e.g., “Today's”) of the response text may be transferred at a first time point, and a first speech signal 603 corresponding to the first section 601 (e.g., “Today's”) of the response text may be output. A second section 605 (e.g., “weather”) of the response text may be transferred at the second time point, and a second speech signal 607 corresponding to the second section 605 (e.g., “weather”) of the response text may be output. A third section 609 (e.g., “is clear”) of the response text may be transferred at a third time point, and a third speech signal 611 corresponding to the third section 609 (e.g., “is clear”) of the response text may be output. In FIG. 6, the next section (e.g., 609) of the response text may be received before the output of the previous speech signal (e.g., 607) is completed (e.g., before the output starts, or before the output starts and the output ends), according to the reception speed of the response text and the generation and playback speed of the response speech.

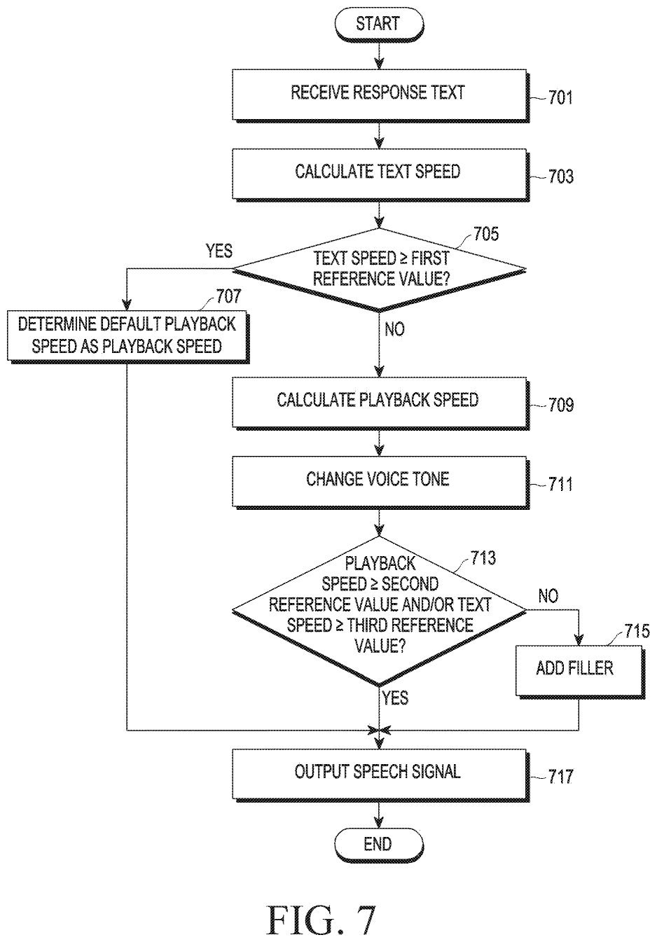

FIG. 7 is a flowchart illustrating an operation method of the electronic device 101 according to an embodiment. FIG. 7 may be described with reference to the above described embodiments and embodiments described below.

At least some of the operations of FIG. 7 may be omitted. The operation order of the operations of FIG. 7 may be changed. At least two of the operations of FIG. 7 may be performed in parallel. Operations other than the operations of FIG. 7 may be performed before, during, or after performing the operations of FIG. 7.

The operations of FIG. 5 may be described in detail with reference to FIG. 7.

Referring to FIG. 7, in operation 701, according to an embodiment, the electronic device 101 (e.g., the processor 120) is configured to receive a response text from the server 108. Operation 701 may be the same as or similar to operation 507 of FIG. 5.

In operation 703, according to an embodiment, the electronic device 101 (e.g., the processor 120) is configured to calculate (or identify or determine) the text speed (e.g., the reception speed of the response text). Operation 703 may be the same as or similar to operation 509 of FIG. 5.

In operation 705, according to an embodiment, the electronic device 101 (e.g., the processor 120) is configured to compare the text speed with a reference value (e.g., a first reference value).

In operation 707, according to an embodiment, the electronic device 101 (e.g., the processor 120) is configured to determine the default playback speed as the playback speed of the response speech, based on the text speed being greater than or equal to the reference value (e.g., the first reference value). The electronic device 101 is configured to determine the default playback speed as the playback speed of the response speech, based on the response text being received at a sufficient speed.

In operation 709, according to an embodiment, the electronic device 101 (e.g., the processor 120) is configured to calculate (or identify or determine) the playback speed of the response speech, based on the text speed being less than the reference value (e.g., the first reference value). The electronic device 101 is configured to calculate (or identify or determine) the playback speed of the response speech lower than the default playback speed, based on the response text being received at an insufficient speed.

In operation 711, according to an embodiment, the electronic device 101 (e.g., the processor 120) is configured to change (or determine) the voice tone of the response speech. Changing the voice tone may be determining the voice tone of the response speech to be different from the default voice tone. The default voice tone may be selected by the user or the electronic device 101. A voice tone different from the default voice tone may be selected by the user or the electronic device 101. For example, the electronic device 101 may change the voice tone of the response speech based on the text speed being less than the reference value (e.g., the first reference value). Operation 711 may be omitted. For example, in operations 709 and 711, based on the text speed being less than the reference value (e.g., the first reference value), the electronic device 101 may determine the playback speed of the response speech to be a playback speed slower than the default playback speed, and may change the voice tone of the response speech. For example, operation 711 may be omitted, and only operation 709 may be performed, so that the electronic device 101 may determine the playback speed of the response speech to be a playback speed slower than the default playback speed, based on the text speed being less than the reference value (e.g., the first reference value), and may determine the voice tone of the response speech to be the default tone.

In operation 713, according to an embodiment, the electronic device 101 (e.g., the processor 120) is configured to compare the playback speed of the response speech with a reference value (e.g., a second reference value). The electronic device 101 is configured to replace the operation (e.g., the first operation) of comparing the playback speed of the response speech with the reference value (e.g., the second reference value) with the operation (e.g., the second operation) of comparing the text speed (e.g., the reception speed of the response text) with a reference value (e.g., a third reference value smaller than the first reference value in operation 705), or perform both the first operation and the second operation. For example, the electronic device 101 may be configured to perform operation 715 based on the playback speed of the response speech being less than the reference value (e.g., the second reference value). For example, the electronic device 101 may be configured to perform operation 715 based on the text speed being less than the reference value (e.g., the third reference value smaller than the first reference value in operation 705).

In operation 715, according to an embodiment, the electronic device 101 (e.g., the processor 120) is configured to determine to add a filler (e.g., an additional speech). The filler (e.g., an additional speech) has been described with reference to FIG. 4.

In operation 717, according to an embodiment, the electronic device 101 (e.g., the processor 120) is configured to output a speech signal. The electronic device 101 may generate a speech signal and may output the speech signal using the speaker 255. The speech signal may include a signal corresponding to the response text and/or a signal corresponding to the filler (e.g., an additional speech).

For example, after operation 707 is performed, the electronic device 101 may be configured to output the speech signal corresponding to the response text, based on the default playback speed of the response speech.

For example, after operation 709 is performed, the electronic device 101 may be configured to output the speech signal corresponding to the response text, based on the playback speed of the response speech slower than the default playback speed and the default voice tone.

For example, after operations 709 and 711 are performed, the electronic device 101 may be configured to output the speech signal corresponding to the response text, based on the playback speed of the response speech slower than the default playback speed and the changed voice tone.

For example, after operations 709 and 715 are performed, the electronic device 101 may be configured to output a first speech signal corresponding to a first section of the response text, an additional speech signal corresponding to a filler (e.g., an additional speech), and a second speech signal corresponding to a second section of the response text, based on the playback speed of the response speech slower than the default playback speed.

For example, after operations 709, 711, and 715 are performed, the electronic device 101 may be configured to output the first speech signal corresponding to the first section of the response text, the additional speech signal corresponding to the filler (e.g., an additional speech), and the second speech signal corresponding to the second section of the response text, based on the playback speed of the response speech slower than the default playback speed and the changed voice tone.

For example, by omitting operations 709 and 711 and performing operations 713 and 715, the electronic device 101 may be configured to output the first speech signal corresponding to the first section of the response text, the additional speech signal corresponding to the filler (e.g., an additional speech), and the second speech signal corresponding to the second section of the response text.

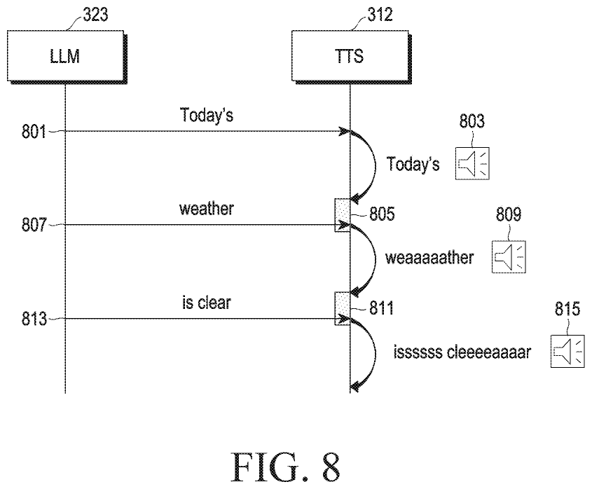

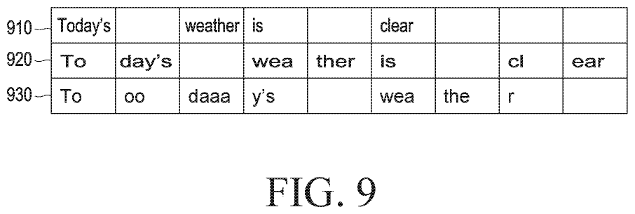

FIG. 8 is a view illustrating operations of an electronic device according to an embodiment. FIG. 9 is a view illustrating operations of an electronic device according to an embodiment.

Referring to FIGS. 8 and 9, a default playback speed, a playback speed slower than the default playback speed, a default voice tone, and a changed voice tone may be described.

FIGS. 8 and 9 are views illustrating an embodiment of outputting a speech signal based on voice change (e.g., a playback speed change and/or a voice tone change) in a state in which a response text is received at an insufficient speed. For example, FIGS. 8 and 9 may illustrate an embodiment in which operation 717 is performed after operation 709 and/or operation 711. For example, referring to FIG. 8, the LLM 323 (e.g., the server 108) is operable to generate response text and provide the generated response text 801, 807, and 813 to the TTS 312 (e.g., the electronic device 101). In FIG. 8, a first section 801 (e.g., “Today's”) of the response text may be transferred at a first time point. A second section 807 (e.g., “weather”) of the response text may be transferred at a second time point. A third section 813 (e.g., “is clear”) of the response text may be transferred at a third time point. As the response text is received at an insufficient speed, the electronic device 101 is configured to determine voice change (e.g., playback speed change and/or voice tone change). The electronic device 101 is configured to determine voice change (e.g., playback speed change and/or voice tone change), based on the text speed. The electronic device 101 is configured to determine voice change (e.g., a playback speed change and/or a voice tone change), based on a period (e.g., 805 or 811) between an output time point (or an output completion time point) of a previous speech signal (e.g., 803 or 809) and a reception time point of a next section (e.g., 807 or 813) of the response text. In FIG. 8, according to the reception speed of the response text and the generation and playback speed of the response speech, the first speech signal 803 corresponding to the first section 801 (e.g., “Today's”) of the response text may be output at the default playback speed and the default voice tone. In FIG. 8, according to the reception speed of the response text and the generation and playback speed of the response speech, the second speech signal 809 corresponding to the second section 807 (e.g., “weather”) of the response text may be output at a playback speed slower than the default playback speed and a changed voice tone. In FIG. 8, according to the reception speed of the response text and the generation and playback speed of the response speech, the third speech signal 815 corresponding to the third section 813 (e.g., “is clear”) of the response text may be output at a playback speed slower than the default playback speed and a changed voice tone. For example, FIG. 9 illustrates an embodiment 910 of the default playback speed and the default voice tone, an embodiment 920 of the playback speed slower than the default playback speed and the default voice tone, and an embodiment 930 of the playback speed slower than the default playback speed and the changed voice tone. FIG. 9 is a view schematically illustrating an uttered speech for each time interval to understand a change in utterance speed, and does not show an accurate time length.

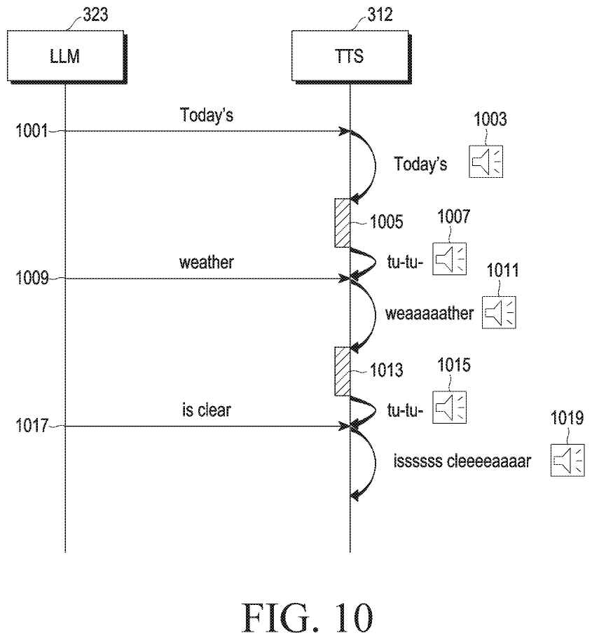

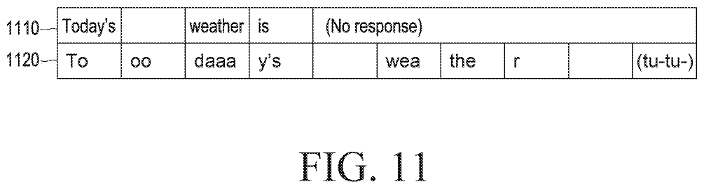

FIG. 10 is a view illustrating operations of an electronic device according to an embodiment. FIG. 11 is a view illustrating operations of an electronic device according to an embodiment.

A filler (e.g., an additional speech) may be described with reference to FIGS. 10 and 11.

FIGS. 10 and 11 are views illustrating an embodiment of outputting a speech signal based on voice change (e.g., playback speed change and/or voice tone change) and filler addition in a state in which a response text is received at an insufficient speed. For example, FIGS. 10 and 11 may illustrate an embodiment in which operation 717 is performed after operation 715. For example, referring to FIG. 10, the LLM 323 (e.g., the server 108) is configured to generate response text and is configured to provide the generated response text 1001, 1009, and 1017 to the TTS 312 (e.g., the electronic device 101). In FIG. 10, a first section 1001 (e.g., “Today's”) of the response text may be transferred at a first time point. A second section 1009 (e.g., “weather”) of the response text may be transferred at a second time point. A third section 1017 (e.g., “is clear”) of the response text may be transferred at a third time point. As the response text is received at an insufficient speed, the electronic device 101 is configured to determine voice change (e.g., playback speed change and/or voice tone change) and filler (e.g., an additional speech) addition. The electronic device 101 is configured to determine voice change (e.g., playback speed change and/or voice tone change), based on the text speed. The electronic device 101 is configured to determine to add a filler (e.g., an additional speech) based on the text speed and/or the playback speed of the response speech. The electronic device 101 is configured to determine to add a voice change (e.g., a playback speed change and/or a voice tone change) and a filler (e.g., 1007, or 1015), based on a period (e.g., 1005 or 1013) between an output time point (or an output completion time point) of the previous speech signal (e.g., 1003 or 1011) and a reception time point of a next section (e.g., 1009, or 1017) of the response text. In FIG. 10, according to the reception speed of the response text and the generation and playback speed of the response speech, the first speech signal 1003 corresponding to the first section 1001 (e.g., “Today's”) of the response text may be output at the default playback speed and the default voice tone. Thereafter, as reception of the second section 1009 (e.g., “weather”) of the response text is delayed, a first filler 1007 (e.g., a beep (e.g., tu-tu-)) may be output. In FIG. 10, according to the reception speed of the response text and the generation and playback speed of the response speech, the second speech signal 1011 corresponding to the second section 1009 (e.g., “weather”) of the response text may be output at a playback speed slower than the default playback speed and a changed voice tone. Thereafter, as reception of the third section 1017 (e.g., “is clear”) of the response text is delayed, a second filler 1015 (e.g., a beep (e.g., tu-tu-)) may be output. In FIG. 10, according to the reception speed of the response text and the generation and playback speed of the response speech, the third speech signal 1019 corresponding to the third section 1017 (e.g., “is clear”) of the response text may be output at a playback speed slower than the default playback speed and a changed voice tone. For example, FIG. 11 illustrates an embodiment 1110 of the default playback speed and the default voice tone, and an embodiment 1120 in which the filler is added in addition to the playback speed slower than the default playback speed and the changed voice tone. In 1110 of FIG. 11, after the first speech signal corresponding to the first section (e.g., “Today's”) of the response text and the second speech signal corresponding to the second section (e.g., “weather”) of the response text are output, reception of the next section of the response text is delayed, and thus no signal is output. Referring to 1120 of FIG. 11, after the first speech signal corresponding to the first section (e.g., “Today's”) of the response text and the second speech signal corresponding to the second section (e.g., “weather”) of the response text are output at a slower playback speed than the default playback speed and a changed voice tone, reception of the next section of the response text is delayed, and thus a filler (e.g., a beep (e.g., tu-tu-)) is output. FIG. 11 is a view schematically illustrating an uttered speech for each time interval to understand a change in utterance speed, and does not show an accurate time length. In the case of 1120 of FIG. 11, the user may recognize that reception of the next section of the response text is delayed as a filler (e.g., a beep (e.g., a tu-tu-)) is output. According to an embodiment, the speech signal may not be output at a slower playback speed than the default playback speed and/or a changed voice tone, and only a filler (e.g., an additional speech) may be added between speech signals. According to an embodiment, a filler (e.g., an additional speech) may be added between sentences. According to an embodiment, a filler (e.g., an additional speech) may be added between words.

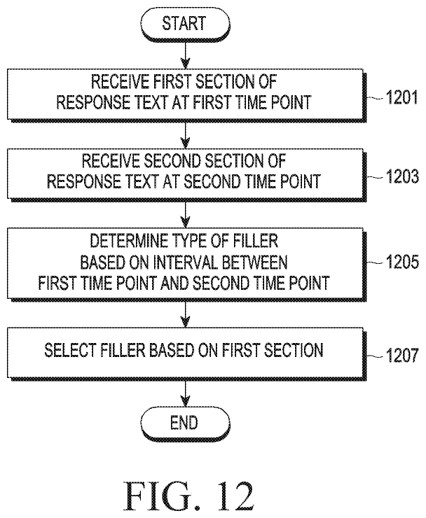

FIG. 12 is a flowchart illustrating an operation method of the electronic device 101 according to an embodiment. FIG. 12 may be described with reference to the above described embodiments and embodiments described below.

At least some of the operations of FIG. 12 may be omitted. The operation order of the operations of FIG. 12 may be changed. At least two of the operations of FIG. 12 may be performed in parallel. Operations other than the operations of FIG. 12 may be performed before, during, or after performing the operations of FIG. 12.

Referring to FIG. 12, in operation 1201, according to an embodiment, the electronic device 101 (e.g., the processor 120) is configured to receive a first section of the response text from the server 108 at a first time point.

In operation 1203, according to an embodiment, the electronic device 101 (e.g., the processor 120) is configured to receive a second section of the response text from the server 108 at a second time point.

In operation 1205, according to an embodiment, the electronic device 101 (e.g., the processor 120) is configured to determine the type of filler (e.g., an additional speech) to be added, based on the interval (or text speed) between the first time point and the second time point. The type of filler (e.g., an additional speech) may include a designated sentence indicating a mute, a designated speech sound, a nasal sound, a natural sound, a beep, white noise, or an output delay. For example, based on the interval (or text speed) between the first time point and the second time point being included in a first range (e.g., a slightly slower degree), the type of filler (e.g., an additional speech) may be determined to be mute (or pause). The length of the mute (or pause) may be determined based on the reception speed of the response text. For example, based on the interval (or the text speed) between the first time point and the second time point being included in a second range (e.g., a medium slow degree), a designated speech sound (e.g., habitual phrases such as “Um . . . ”, “Wait a minute”, “Well . . . ”, “you know . . . ”, and “So . . . ”) or a designated non-speech sound (e.g., natural sound (e.g., wind sound, non-sound), beep (e.g., tu-tu-), and white noise) may be determined as a filler (e.g., an additional speech). For example, based on the interval (or text speed) between the first time point and the second time point being included in a third range (e.g., a very slow degree), a designated sentence (e.g., “the answer is being delayed somewhat”) indicating the output delay may be determined as a filler (e.g., an additional speech). For example, the filler (e.g., an additional speech) may be a sound recorded with a voice different from that of the TTS 312. For example, the filler (e.g., the additional speech) may be synthesized by a second TTS (e.g., the TTS 312) corresponding to a second voice type, which is different from a first TTS (e.g., the TTS 312) corresponding to a first voice type. The filler (e.g., an additional speech) may be selected by the user. The filler (e.g., an additional speech) may be repeatedly played. For example, the repeated playback time of the filler (e.g., an additional speech) may be designated by the user or may be determined by the electronic device 101 based on the reception speed of the response text. The magnitude (e.g., volume) of the output of the filler (e.g., an additional voice) may be determined based on the interval (or text speed) between the first time point and the second time point. For example, the electronic device 101 is configured to determine the magnitude of the output of the filler based on the interval between the first time point and the second time point. For example, the electronic device 101 is configured to determine that the magnitude of the output of the filler naturally increases from a small volume to a certain level of volume in proportion to the time for waiting for the response text.

In operation 1207, according to an embodiment, the electronic device 101 (e.g., the processor 120) is configured to identify the first section of the response text and select the filler based on the first section. The electronic device 101 is configured to select one filler based on the first section of the response text from among a plurality of fillers included in the determined type of filler. For example, the electronic device 101 is configured to analyze the context of the first section of the response text, and is configured to select a filler (e.g., a filler designated according to the content included in the first section) that matches the content included in the first section, based on the analysis result. Accordingly, as the content included in the first section of the response text is changed, a different filler may be selected.

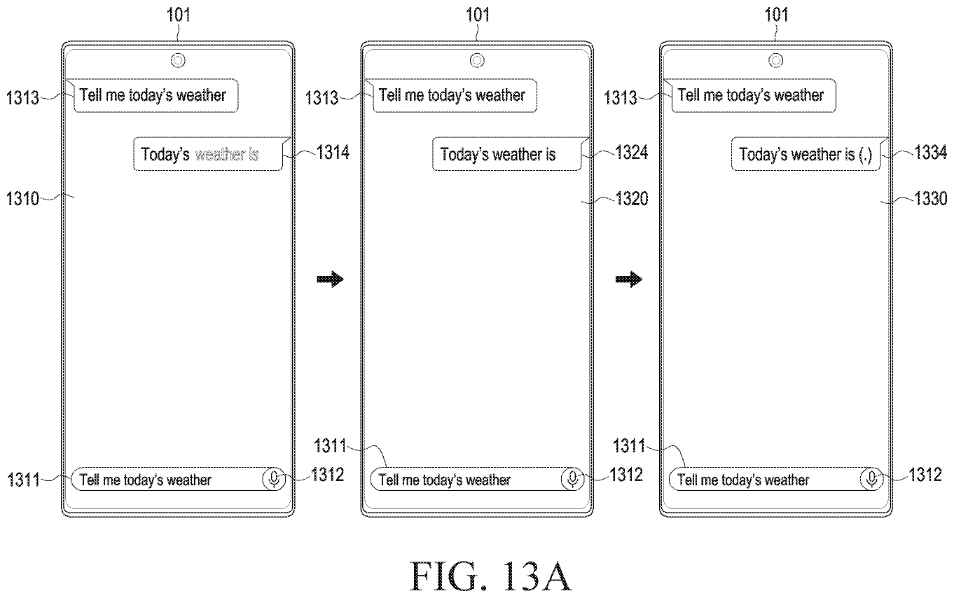

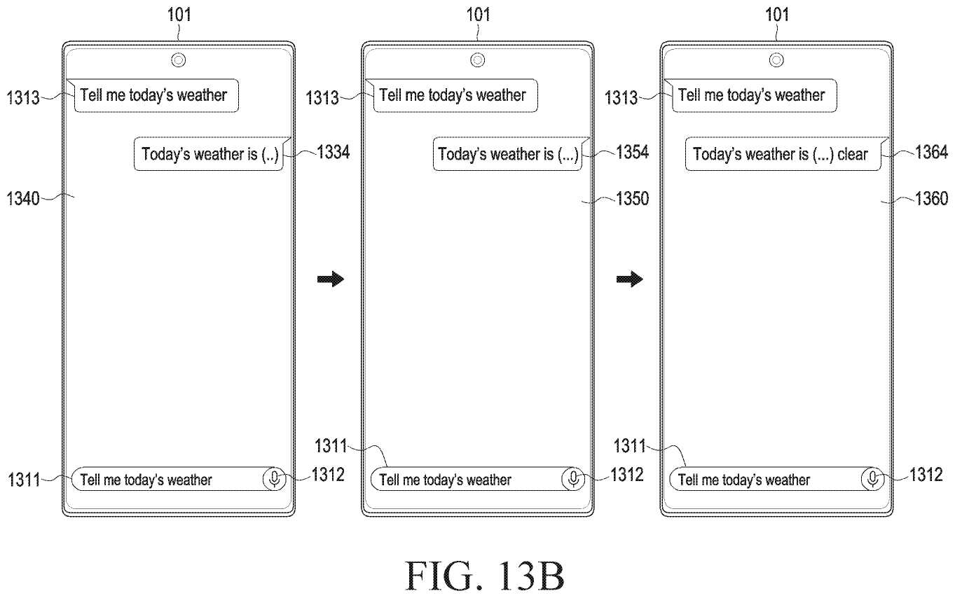

FIG. 13A is a view illustrating operations of an electronic device according to an embodiment. FIG. 13B is a view illustrating operations of an electronic device according to an embodiment.

The display of the response text may be described with reference to FIGS. 13A and 13B. For example, the electronic device 101 is configured to display a screen including the response text on the display 260 while outputting the speech signal corresponding to the response text. In FIGS. 13A and 13B, the electronic device 101 is configured to display a response text (e.g., “Today's weather is clear”) generated based on the user input (e.g., “Tell me today's weather”) on a screen (e.g., 1310, 1320, 1330, 1340, 1350, and 1360).

The screens 1310, 1320, 1330, 1340, 1350, and 1360 of FIGS. 13A and 13B are sequentially described as follows. Hereinafter, the first section of the response text is expressed as the first response text. In the screens 1310, 1320, 1330, 1340, 1350, and 1360 of FIGS. 13A and 13B, 1311 may indicate that an input text corresponding to the user input is displayed in a text input window. In the screens 1310, 1320, 1330, 1340, 1350, and 1360 of FIGS. 13A and 13B, 1312 may be a button for receiving a speech input of the user. In the screens 1310, 1320, 1330, 1340, 1350, and 1360 of FIGS. 13A and 13B, 1313 may be an input text corresponding to the user input, displayed in a dialog form.

The first screen 1310 may be a screen 1314 on which the first response text (“Today's”) and the second response text (“weather”) are displayed while the first speech signal corresponding to the first response text (“Today's”) is output. In this case, the first response text (“Today's”) and the second response text (“weather”) may have different attributes. For example, when the speech signal corresponding to the response text (e.g., the first response text) is being output or has already been output, the corresponding response text may be displayed in a dark color, and when the response text (e.g., the second response text) has been received but has not yet been output, the response text may be displayed in a light color. The display attribute (e.g., color) of the response text is merely an example, and various attributes may be applied.

The second screen 1320 is a screen indicating that the attribute (e.g., color) of the second response text (“weather”) is changed (1324) as the second speech signal corresponding to the second response text (“weather”) is output after the first speech signal corresponding to the first response text (“Today's”) is output.

The third screen 1330 may be a screen 1334 in which a text or an image (e.g., “(.)”) corresponding to the filler is displayed while the filler (e.g., an additional speech) is output, based on the next section of the response text being not received after the second speech signal corresponding to the second response text (“weather”) is output. The fourth screen 1340 and the fifth screen 1350 may be screens in which the text or image (e.g., “(..)” or “(...)”) corresponding to the filler keeps being displayed (1344, 1354) while the filler is continuously output. In the third screen 1330, the fourth screen 1340, and the fifth screen 1350, the number of periods (.) may increase in the text or image (e.g., ““(.)”, “(.)”)”, “(...)”) corresponding to the filler based on the next section of the response text being not continuously received. The text or image corresponding to the filler may be a text or image indicating insertion of the filler. The text or image corresponding to the filler is not limited to “(.)”, “(..)”, or “(...)” of FIGS. 13A and 13B. The text or image corresponding to the filler may be displayed in a text box as shown in FIGS. 13A and 13B, or may be displayed in an area other than the text box on the screen.

The sixth screen 1360 is a view displaying (1364) a third response text (“is clear”) while outputting the third speech signal corresponding to the third response text (“is clear”) based on reception of the third response text (“is clear”) while the filler is output.

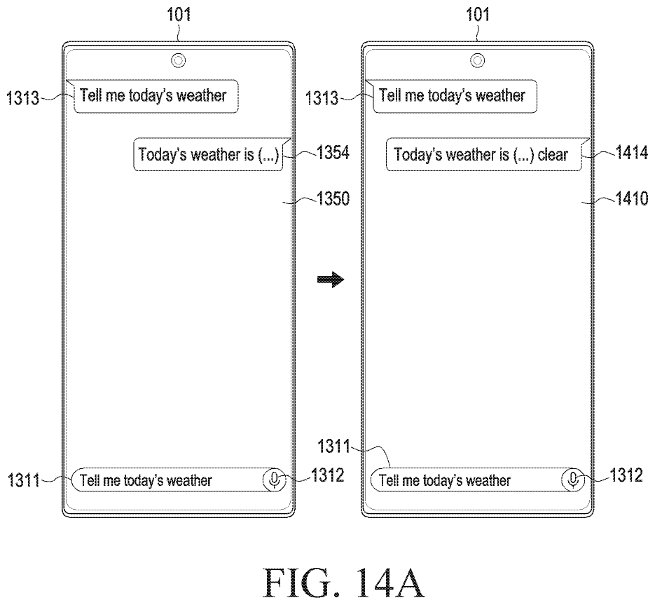

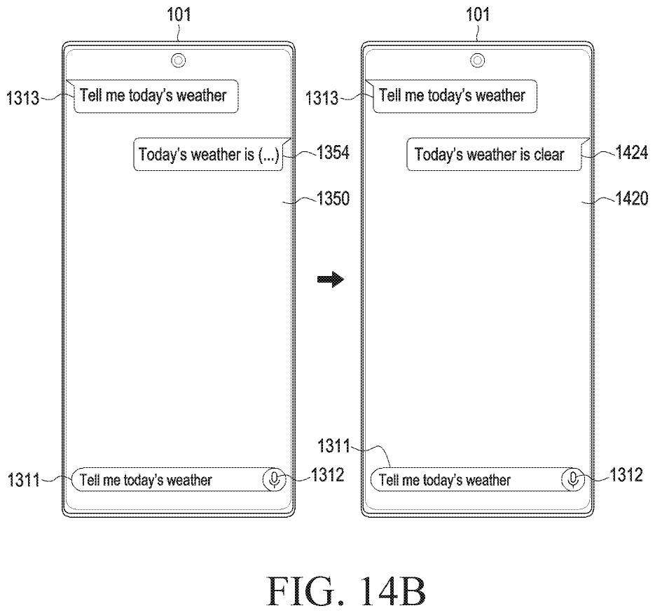

FIG. 14A is a view illustrating operations of an electronic device according to an embodiment. FIG. 14B is a view illustrating operations of an electronic device according to an embodiment.

FIG. 14A illustrates an embodiment in which the sixth screen 1360 (e.g., 1410 including 1414) of FIG. 13B is displayed after the fifth screen 1350 of FIG. 13B is displayed. FIG. 14A may be understood in the same or similar manner to the display of the screen of FIG. 13B.

FIG. 14B is a view illustrating an embodiment in which display of a text or an image corresponding to a filler is stopped after the fifth screen 1350 of FIG. 13B is displayed. For example, as reception of the next response text is delayed after displaying the previous response text (e.g., “Today”, “Weather”), the electronic device 101 may display the text or image (e.g., “(...)”) corresponding to the filler while outputting the filler. Thereafter, the electronic device 101 may stop displaying the text or image (e.g., “(...)”) corresponding to the filler while outputting the speech signal corresponding to the received response text and display the received response text on the screen (e.g., 1420 including 1424) based on reception of the next response text (e.g., “is clear.”). As described above, the text or image corresponding to the filler is one for indicating insertion of the filler, and a text or image other than “(...)” may be used.

It may be understood by one of ordinary skill in the art that embodiments described herein may be applied interchangeably within the applicable scope. For example, it will be understood by one of ordinary skill in the art that at least some operations of an embodiment described in the disclosure may be omitted and applied, or at least some operations of an embodiment may be interchangeably applied.

Technical objects to be achieved herein are not limited to the foregoing technical objects, and other technical objects not mentioned may be clearly understood by those skilled in the art from the following description.

Effects obtainable from the disclosure are not limited to the above-mentioned effects, and other effects not mentioned may be clearly understood by those skilled in the art from the following description.

According to an embodiment, an electronic device 101 may comprise communication circuitry 190 or 290, a speaker 155 or 255, a processor 120, and memory 130 storing instructions. The instructions may be configured to, when executed by the processor 120, enable the electronic device 101 to transmit, to a server 108 through the communication circuitry 190 or 290, an input text corresponding to a user input. The instructions may be configured to, when executed by the processor 120, enable the electronic device 101 to receive, from the server 108 through the communication circuitry 190 or 290, a response text corresponding to the input text, generated by the server 108. The instructions may be configured to, when executed by the processor 120, enable the electronic device 101 to identify a reception speed of the response text. The instructions may be configured to, when executed by the processor 120, enable the electronic device 101 to, based on the reception speed, determine an attribute of a response speech corresponding to the response text. The instructions may be configured to, when executed by the processor 120, enable the electronic device 101 to, based on the attribute of the response speech, output, through the speaker 155 or 255, a speech signal corresponding to the response text.

The instructions may be configured to, when executed by the processor 120, enable the electronic device 101 to, at a first time point, receive a first section of the response text from the server 108 through the communication circuitry 190 or 290. The instructions may be configured to, when executed by the processor 120, enable the electronic device 101 to, at a second time point after the first time point, receive a second section of the response text from the server 108 through the communication circuitry 190 or 290. The instructions may be configured to, when executed by the processor 120, enable the electronic device 101 to, based on the attribute of the response speech, output a first speech signal corresponding to the first section of the response text, and output a second speech signal corresponding to the second section.

According to an embodiment, the attribute of the response speech may include a playback speed of the response speech.

According to an embodiment, the instructions may be configured to, when executed by the processor 120, enable the electronic device 101 to, based on the reception speed corresponding to the response text being greater than or equal to a first reference value, determine a default playback speed as the playback speed of the response speech. The instructions may be configured to, when executed by the processor 120, enable the electronic device 101 to, based on the reception speed corresponding to the response text being less than the first reference value, determine the playback speed of the response speech to be slower than the default playback speed.

According to an embodiment, the instructions may be configured to, when executed by the processor 120, enable the electronic device 101 to, based on the reception speed being less than a second reference value, output a filler after outputting the first speech signal and before outputting the second speech signal.

According to an embodiment, the instructions may be configured to, when executed by the processor 120, enable the electronic device 101 to, based on an interval between the first time point and the second time point, determine a size of the output of the filler.

According to an embodiment, the instructions may be configured to, when executed by the processor 120, enable the electronic device 101 to generate the first speech signal and the second speech signal using a first text-to-speech (TTS) corresponding to a first voice type. The instructions may be configured to, when executed by the processor 120, enable the electronic device 101 to generate the filler using a second TTS corresponding to a second voice type.

According to an embodiment, the instructions may be configured to, when executed by the processor 120, enable the electronic device 101 to, based on an interval between the first time point and the second time point, determine a type of the filler.

According to an embodiment, the type of the filler may include a silence, a designated voice sound, a nasal sound, a natural sound, a beep, a white noise, or a designated sentence indicating output delay.

According to an embodiment, the instructions may be configured to, when executed by the processor 120, enable the electronic device 101 to, based on the first section of the response text, select one of fillers included in the determined type of the filler.

According to an embodiment, the instructions may be configured to, when executed by the processor 120, enable the electronic device 101 to identify the reception speed corresponding to the response text, based on intervals between sections of the response text and a number of words received per unit time of the response text. The instructions may be configured to, when executed by the processor 120, enable the electronic device 101 to, based on the identified reception speed, predict the reception speed of the response text to be received later. The instructions may be configured to, when executed by the processor 120, enable the electronic device 101 to, based on the identified reception speed and the predicted reception speed, determine the attribute of the response speech.

According to an embodiment, the electronic device 101 may further comprise a display 160 or 260. The instructions may be configured to, when executed by the processor 120, enable the electronic device 101 to, through the display 160 or 260, display a first text corresponding to the first speech signal, display a text corresponding to the filler, and display a second text corresponding to the second speech signal.

According to an embodiment, the instructions may be configured to, when executed by the processor 120, enable the electronic device 101 to stop displaying the text corresponding to the filler and display the second text corresponding to the second speech signal to display the second text after displaying the text corresponding to the filler.

According to an embodiment, a method for operating an electronic device 101 may comprise transmitting an input text corresponding to a user input to a server 108. The method may comprise receiving, from the server 108, a response text corresponding to the input text, generated by the server 108. The method may comprise identifying a reception speed of the response text. The method may comprise, based on the reception speed, determining an attribute of a response speech corresponding to the response text. The method may comprise outputting a speech signal corresponding to the response text, based on the attribute of the response speech.

According to an embodiment, receiving the response text from the server 108 may include receiving a first section of the response text from the server 108 at a first time point. Receiving the response text from the server 108 may include receiving a second section of the response text from the server 108 at a second time point after the first time point. Outputting the speech signal may include, based on the attribute of the response speech, outputting a first speech signal corresponding to the first section of the response text, and output a second speech signal corresponding to the second section.

According to an embodiment, the attribute of the response speech may include a playback speed of the response speech.

According to an embodiment, determining the attribute of the response speech may include, based on the reception speed corresponding to the response text being greater than or equal to a first reference value, determining a default playback speed as the playback speed of the response speech. Determining the attribute of the response speech may include, based on the reception speed corresponding to the response text being less than the first reference value, determining the playback speed of the response speech to be slower than the default playback speed.

According to an embodiment, the method may comprise, based on the reception speed being less than a second reference value, outputting a filler after outputting the first speech signal and before outputting the second speech signal.

According to an embodiment, the method may determine a size of the output of the filter based on an interval between the first time point and the second time point.

According to an embodiment, outputting the speech signal may include generating the first speech signal and the second speech signal using a first text-to-speech (TTS) corresponding to a first voice type. Outputting the speech signal may include generating the filler using the second TTS corresponding to the second voice type.

According to an embodiment, the method may determine a type of the output of the filter based on an interval between the first time point and the second time point.

According to an embodiment, the type of the filler may include a silence, a designated voice sound, a nasal sound, a natural sound, a beep, a white noise, or a designated sentence indicating output delay.

According to an embodiment, the method may comprise, based on the first section of the response text, selecting one of fillers included in the determined type of the filler.

According to an embodiment, identifying the reception speed may include identifying the reception speed corresponding to the response text, based on intervals between sections of the response text and a number of words received per unit time of the response text. Identifying the reception speed may include predicting the reception speed of the response text to be received later based on the identified reception speed. Determining the attribute of the response speech may include determining the attribute of the response speech based on the identified reception speed and the predicted reception speed.

According to an embodiment, the method may comprise, through a display 160 or 260 of the electronic device 101, displaying a first text corresponding to the first speech signal, displaying a text corresponding to the filler, and displaying a second text corresponding to the second speech signal.

According to an embodiment, displaying the second text may include stopping displaying the text corresponding to the filler and displaying the second text corresponding to the second speech signal to display the second text after displaying the text corresponding to the filler.

According to an embodiment, in a computer-readable recording medium storing instructions configured to perform at least one operation by a processor 120 of an electronic device 101, the at least one operation may comprise transmitting an input text corresponding to a user input to a server 108. The at least one operation may comprise receiving, from the server 108, a response text corresponding to the input text, generated by the server 108. The at least one operation may comprise identifying a reception speed of the response text. The at least one operation may comprise, based on the reception speed, determining an attribute of a response speech corresponding to the response text. The at least one operation may comprise outputting a speech signal corresponding to the response text, based on the attribute of the response speech.

According to an embodiment, receiving the response text from the server 108 may include receiving a first section of the response text from the server 108 at a first time point. Receiving the response text from the server 108 may include receiving a second section of the response text from the server 108 at a second time point after the first time point. Outputting the speech signal may include, based on the attribute of the response speech, outputting a first speech signal corresponding to the first section of the response text, and output a second speech signal corresponding to the second section.

According to an embodiment, the attribute of the response speech may include a playback speed of the response speech.

According to an embodiment, determining the attribute of the response speech may include, based on the reception speed corresponding to the response text being greater than or equal to a first reference value, determining a default playback speed as the playback speed of the response speech. Determining the attribute of the response speech may include, based on the reception speed corresponding to the response text being less than the first reference value, determining the playback speed of the response speech to be slower than the default playback speed.

According to an embodiment, the at least one operation may comprise, based on the reception speed being less than a second reference value, outputting a filler after outputting the first speech signal and before outputting the second speech signal.

According to an embodiment, the at least one operation may determine a size of the output of the filter based on an interval between the first time point and the second time point.

According to an embodiment, outputting the speech signal may include generating the first speech signal and the second speech signal using a first text-to-speech (TTS) corresponding to a first voice type. Outputting the speech signal may include generating the filler using the second TTS corresponding to the second voice type.

According to an embodiment, the at least one operation may determine a type of the output of the filter based on an interval between the first time point and the second time point.

According to an embodiment, the type of the filler may include a silence, a designated voice sound, a nasal sound, a natural sound, a beep, a white noise, or a designated sentence indicating output delay.

According to an embodiment, the at least one operation may comprise, based on the first section of the response text, selecting one of fillers included in the determined type of the filler.

According to an embodiment, identifying the reception speed may include identifying the reception speed corresponding to the response text, based on intervals between sections of the response text and a number of words received per unit time of the response text. Identifying the reception speed may include predicting the reception speed of the response text to be received later based on the identified reception speed. Determining the attribute of the response speech may include determining the attribute of the response speech based on the identified reception speed and the predicted reception speed.

According to an embodiment, the at least one operation may comprise, through a display 160 or 260 of the electronic device 101, displaying a first text corresponding to the first speech signal, displaying a text corresponding to the filler, and displaying a second text corresponding to the second speech signal.

According to an embodiment, displaying the second text may include stopping displaying the text corresponding to the filler and displaying the second text corresponding to the second speech signal to display the second text after displaying the text corresponding to the filler.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium that is readable by a machine (e.g., an electronic device). For example, a processor (e.g., a controller) of the machine may invoke at least one of the one or more instructions stored in the storage medium, and execute it. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device (101) comprising:
communication circuitry (190; 290);
a speaker (155; 255);
a processor (120); and
memory (130) storing instructions,
wherein the instructions are configured to, when executed by the processor (120), enable the electronic device (101) to:
transmit, to a server (108) through the communication circuitry (190; 290), an input text corresponding to a user input,
receive, from the server (108) through the communication circuitry (190; 290), a response text corresponding to the input text, generated by the server (108),
identify a reception speed of the response text,
based on the reception speed, determine an attribute of a response speech corresponding to the response text, and
based on the attribute of the response speech, output, through the speaker (155; 255), a speech signal corresponding to the response text.

2. The electronic device (101) of claim 1, wherein the instructions are configured to, when executed by the processor (120), enable the electronic device (101) to:
at a first time point, receive a first section of the response text from the server (108) through the communication circuitry (190; 290);
at a second time point after the first time point, receive a second section of the response text from the server (108) through the communication circuitry (190; 290); and
based on the attribute of the response speech, output a first speech signal corresponding to the first section of the response text, and output a second speech signal corresponding to the second section.

3. The electronic device (101) of claim 1, wherein the attribute of the response speech includes a playback speed of the response speech.

4. The electronic device (101) of claim 3, wherein the instructions are configured to, when executed by the processor (120), enable the electronic device (101) to:
based on the reception speed corresponding to the response text being greater than or equal to a first reference value, determine a default playback speed as the playback speed of the response speech; and
based on the reception speed corresponding to the response text being less than the first reference value, determine the playback speed of the response speech to be slower than the default playback speed.

5. The electronic device (101) of claim 2, wherein the instructions are configured to, when executed by the processor (120), enable the electronic device (101) to:
based on the reception speed being less than a second reference value, output a filler after outputting the first speech signal and before outputting the second speech signal.

6. The electronic device (101) of claim 5, wherein the instructions are configured to, when executed by the processor (120), enable the electronic device (101) to:
based on an interval between the first time point and the second time point, determine a size of the output of the filler.

7. The electronic device (101) of claim 5, wherein the instructions are configured to, when executed by the processor (120), enable the electronic device (101) to:
generate the first speech signal and the second speech signal using a first text-to-speech (TTS) corresponding to a first voice type; and
generate the filler using a second TTS corresponding to a second voice type.

8. The electronic device (101) of claim 5, wherein the instructions are configured to, when executed by the processor (120), enable the electronic device (101) to:
based on an interval between the first time point and the second time point, determine a type of the filler.

9. The electronic device (101) of claim 8, wherein the type of the filler includes a silence, a designated voice sound, a nasal sound, a natural sound, a beep, a white noise, or a designated sentence indicating output delay.

10. The electronic device (101) of claim 8, wherein the instructions are configured to, when executed by the processor (120), enable the electronic device (101) to:
based on the first section of the response text, select one of fillers included in the determined type of the filler.

11. The electronic device (101) of claim 1, wherein the instructions are configured to, when executed by the processor (120), enable the electronic device (101) to:
identify the reception speed corresponding to the response text, based on intervals between sections of the response text and a number of words received per unit time of the response text;
based on the identified reception speed, predict the reception speed of the response text to be received later; and
based on the identified reception speed and the predicted reception speed, determine the attribute of the response speech.

12. The electronic device (101) of claim 5, further comprising:
a display (160; 260),
wherein the instructions are configured to, when executed by the processor (120), enable the electronic device (101) to:
through the display (160; 260), display a first text corresponding to the first speech signal,
display a text corresponding to the filler, and
display a second text corresponding to the second speech signal.

13. The electronic device (101) of claim 12, wherein the instructions are configured to, when executed by the processor (120), enable the electronic device (101) to:
stop displaying the text corresponding to the filler; and
display the second text corresponding to the second speech signal to display the second text after displaying the text corresponding to the filler.

14. A method for operating an electronic device (101), the method comprising:
transmitting an input text corresponding to a user input to a server (108);
receiving, from the server (108), a response text corresponding to the input text, generated by the server (108);
identifying a reception speed of the response text;
based on the reception speed, determining an attribute of a response speech corresponding to the response text; and
outputting a speech signal corresponding to the response text, based on the attribute of the response speech.

15. A computer-readable recording medium storing instructions configured to perform at least one operation by a processor (120) of an electronic device (101), the at least one operation comprising:
transmitting an input text corresponding to a user input to a server (108);
receiving, from the server (108), a response text corresponding to the input text, generated by the server (108);
identifying a reception speed of the response text;
based on the reception speed, determining an attribute of a response speech corresponding to the response text; and
outputting a speech signal corresponding to the response text, based on the attribute of the response speech.
